(19) United States
(12) Patent Application Publication
(10) Pub. No.: US 2005/0177696 A1
(43) Pub. Date: Aug. 11, 2005

(54) Over the air memory allocation modification

(76) Inventors: Ronald R. Smith, Coral Springs, FL (US); Josue Pena, Pembroke Pines, FL (US); Ruiqiang Zhuang, Plantation, FL (US); Jose E. Korneluk, Boynton Beach, FL (US); Dale R. Crosby, Coral Springs, FL (US)

Correspondence Address: AKERMAN SENTERFITT, P.O. BOX 3188, WEST PALM BEACH, FL, 33402-3188, US

(21) Appl. No.: 10/772,741

(22) Filed: Feb. 5, 2004

(51) Int. Cl. G06F 12/00

(52) U.S. Cl. 711/170

(57) ABSTRACT

A communication system includes a base transmitter (110) for transmitting a signal over the air indicating a reallocation of a non-removable memory within a portable communication device (200), a non-removable memory (212) within the communication device preconfigured with a first amount of space allocated for random access memory and a second amount of space allocated for a heap, and a processor (208) coupled to the non-removable memory. The processor can be programmed to receive the signal over the air to re-allocate at least the first amount of space and the second amount of space in accordance with the signal.

### CROSS-REFERENCE TO RELATED APPLICATIONS

Not applicable

### FIELD OF THE INVENTION

This invention relates generally to memory reallocation in communication devices, and more particularly to a method and system for reallocating memory using over the air signaling.

### BACKGROUND OF THE INVENTION

Currently many embedded device manufacturers produce a platform for their devices that are used across a range of products and will last for one or more “upgrades” or new feature software releases. RAM is typically only available in sizes that double in the same package footprint, so often the only option is to double the amount of RAM when only a little more memory is actually needed (e.g. using a 2 Megabyte chip when only a little more than 1 Megabyte of RAM is actually needed). Often, the next release of software must have new features that are required to fit in the same part due to cost constraints (e.g., providing a new browser feature in a subsequent release without increasing cost and remaining within a certain hardware price point.) This can mean that the platform must “reserve” room to fit the new feature and must decrease the size of other features available RAM in order not to be perceived to have “degraded” in an upgraded model. (e.g. a new Browser needs 512 k of RAM so a Java Heap space needs to be decreased by 400 k to insure it will fit in the new release). In such a scenario, a current product would ship with unused RAM which is a waste of valuable resources.

### SUMMARY OF THE INVENTION

A method and system of reallocating non-removable memory in a communication device can include transmission and reception of a signal indicating such reallocation. Such a system provides device manufacturers and service providers added flexibility to enhance features and services without necessarily increasing hardware costs.

In a first embodiment of the present invention, a method of reallocating memory in a communication device includes the steps of receiving a signal over the air indicating a reallocation of non-removable memory or a revision of a memory map in the communication device and reallocating the non-removable memory in accordance with the signal. The signal can be among other things packet data or a layer 3 message for a specific subscriber. The reallocation can be at least between a random access memory and a java heap within the communication device or between FDI blocks and a DAV space of a flash memory device. Since the memory is non-removable, such memory can provide high-speed access to a processor within the communication device. The method can also include the step of billing a subscriber of a service using the communication device for the step of reallocating the memory.

In a second embodiment of the present invention, a communication device can include a non-removable memory preconfigured with a first amount of space allocated for random access memory and a second amount of space allocated for a heap and a processor coupled to the non-removable memory. The processor can be programmed to receive a signal over the air to re-allocate at least the first amount of space and the second amount of space in accordance with the signal. The memory heap can be a java heap and the communication device can be any device among a cellular phone, a two-way pager, a trunked-two-way radio, an iDEN radio, and a smart phone for example.

In a third embodiment of the present invention, a communication system includes a base transmitter for transmitting a signal over the air indicating a reallocation of a non-removable memory within a portable communication device, a non-removable memory within the communication device preconfigured with a first amount of space allocated for random access memory and a second amount of space allocated for a heap, and a processor coupled to the non-removable memory. The processor can be programmed to receive the signal over the air to re-allocate at least the first amount of space and the second amount of space in accordance with the signal.

### BRIEF DESCRIPTION OF THE DRAWINGS

FIG. 1 is a block diagram of a communication system capable of reallocating memory within a communication device in accordance with the present invention.

FIG. 2 is a block diagram of a communication device capable of reallocating memory in accordance with present invention.

FIG. 3 illustrates a several memory maps in accordance with the present invention.

FIG. 4 is a flow chart illustrating a method of reallocating memory in a communication device in accordance with the present invention.

### DETAILED DESCRIPTION OF THE DRAWINGS

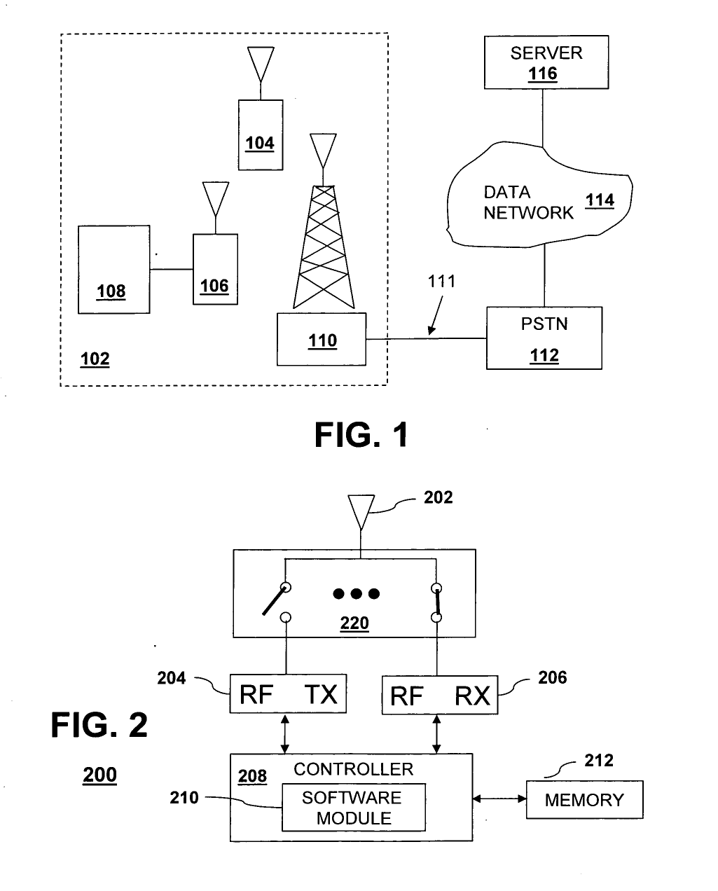

Referring to FIG. 1, a communication system 102 in accordance with an embodiment of the present invention includes multiple subscriber units 104, 106 (two shown) and a communication system infrastructure 110 such as a cellular phone system, a two-way paging system or a two way radio system. The communication system infrastructure 110 can be connected to a Public Switched Telephone Network (PSTN) 112 through a communication link 111, such as a frame relay link. Communication link 111 allows communication units 104, 106 to communicate over PSTN 112. PSTN 112 is connected to a data network 114, preferably the Internet, and via data network 114 to a server 116 such as a web-based server.

In one embodiment, an external call having instructions or signals for reallocating memory within a communication device can be initiated from PSTN 112, or from a web-based server such as server 116 via data network 114 and PSTN 112. The instructions can be directed toward any one or all of the communication devices 104, 106. PSTN 112 will send the call notification and source identification information over communication link 111 to communication system 102, where infrastructure 110 will forward the call to an appropriate communication device 104, 106 and reserve a communication channel for communication with the communication device. Subsequently or concurrently, the instructions or signals for reallocating memory can be transmitted via the communication channel to the appropriate communication devices.

Alternatively, a first communication device 104 of the multiple communication devices 104, 106 may make a call to another communication device, such as communication device 106. The call may be directly from communication device 104 to communication device 106, or the call may be facilitated by infrastructure 110. Furthermore, the call may be a private call to a single communication device or the call can be to multiple other communication devices. Communication device 106 receives notification of the call from either infrastructure 110 or communication device 104, and either one of the two participating communication devices 104, 106 or infrastructure 110 may reserve a communication channel for communication between the two devices. In another alternative, a data terminal equipment device 108 (such as a computer, workstation, or even a personal digital assistant) coupled to the communication device 106 can initiate the call to communication device 104. In any event, as in the prior example, the instructions or signals for reallocating memory can be transmitted via the communication channel to the appropriate communication devices.

Each communication device 104, 106 can be an “iDEN” radiotelephone that is commercially available from Motorola, Inc. of Schaumburg, Ill., and that is modified to provide for the functionality of the present invention. As shown in FIG. 2, each communication device 104, 106 can come in the form of a communication unit 200 that includes a radio frequency receiver 206 and a radio frequency transmitter 204, both electrically coupled to an antenna 202 via an antenna port 220, such as an antenna switch, as is common in the art. Receiver 206 and transmitter 204 can each be coupled to a controller 208, such as a microprocessor for operating the communication device 104, 106. Controller 208 operates according to a set of instruction codes stored in a memory 212. Controller 208 can further be connected to each of multiple input and output ports (not shown). The multiple input and output ports can further include a serial data terminal port that transmits data to, and receives data from, an end user such as the data terminal equipment (DTE) 108. The DTE 108 can also be used to reallocate the memory 212 if desired. Note the memory 212 can be random access memory, FLASH memory, or any other non-removable memory. Additionally, the memory 212 preferably has direct and high-speed access to the controller or processor 208.

When information is received by a communication device 104, 106 via one of multiple ports or over the air via the antenna 202, the information can be demodulated and digitized, if not already in a digital format, and processed by one or more tasks running in a software module 210 embedded in controller 208. The digitized data is then routed by software module 210 to a software application, or process, running in software module 210 to facilitate a processing or reallocation of the memory 212.

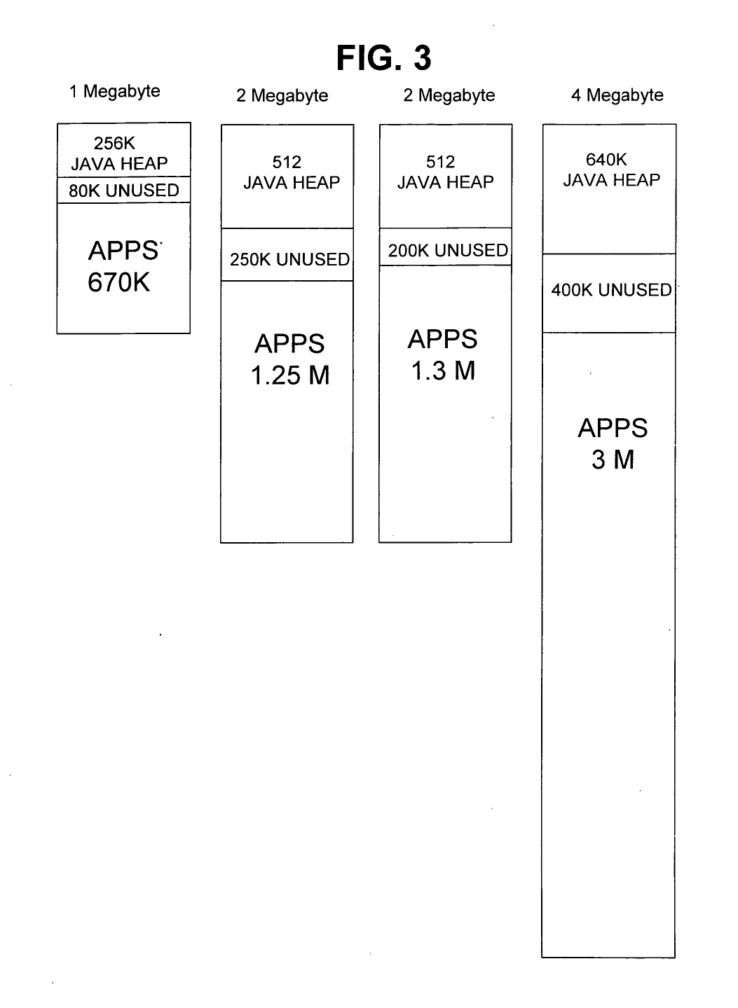

Referring to FIG. 3, several memory allocation scenarios are illustrated. Currently, Motorola's iDEN phones allocate all of the remaining RAM to a Java Heap. For example, a phone with a 1 Megabyte RAM can have 336 Kilobytes allocated to a Java heap and 670 Kilobytes to applications. This 1 Megabyte RAM memory can be reallocated in any number of ways including a reallocation as shown where 256K is allocated to the Java heap, 670K to applications, and 80K remains unused or reserved. Using an embodiment of the present invention, increments of RAM can be added to the Java heap or for application use via signaling from the network. An over the air command, transmitted via the network (packet data or layer 3 messaging) to a specific subscriber would enable the Java platform (or any feature) to access more of the memory. In this manner, the typical out-of-the-box device would have enough space for the new feature, but users would still be able to access the unused portion of RAM in units that have extra RAM available. Thus, the phone can be shipped with memory that is unallocated as shown in each of the examples of FIG. 3. For example, a phone with a 2 Megabyte RAM can initially be configured with a 512K Java Heap, a 1.25 Megabyte memory portion for applications and 250K memory portion reserved as “unused” memory. Upon determining that additional memory needs to be reallocated for applications, the 2 Megabyte RAM can be re-configured with a 512K Java Heap, a 1.3 Megabyte memory portion for applications and 200K memory portion reserved as “unused” memory. Another exemplary configuration for a phone with a 4 Megabyte RAM can have a 640K Java Heap, a 3 Megabyte memory portion for applications and a 400K memory portion reserved as “unused” memory. Once again, an over-the-air signal can reallocate the memory among the 3 different memory portions of the RAM. Of course, the memory can have any number of memory portions and the reallocation can be done among any of the portions as desired.

One scenario where an embodiment of the present invention can be put to use occurs when software developers write applications that cannot install on a device since the heap is used for installation. This heap could be “upgraded” by adding or reallocating additional RAM over the air to the Java heap. Then the application can install on the device and the unused RAM on a communication device does not go to waste. The service provider could then charge a fee for this memory upgrade.

Another scenario that can utilize an embodiment of the present invention is a flash memory that apportion memory between FDI blocks and a DAV portion of a flash memory. An Intel FDI Code Manager allocates a group of flash blocks called the Direct Access Volume (DAV), in which it stores and manages code objects. This method of storing and managing code provides direct execution of code from flash without the intermediate step of loading the code to RAM. Two important applications for the Code Manager are processor code management and Java*applet management. Processor code consists of CPU binary instructions that are directly fetched and executed by the system CPU Java applets and contain compiled byte codes that are fetched and interpreted by a Java Virtual Machine.

A flash memory using an (Flash Data Integrator) FDI as described above in an iDEN phone, for example, can dynamically redistribute Flash memory allocation between DAV and FDI on demand when the user downloads new applications (games, etc) or a subscriber SW update. For example, if a user wants to download more applications than currently fits in the allocated DAV space, a download utility checks to see if there is any unused FDI space. If there is sufficient unused FDI space, then the download utility instructs the phone to redistribute the Flash sectors to convert free (empty) FDI blocks to DAV space. After the re-allocation is complete, then the applications are downloaded. In another example, if a user wants to download a subscriber software upgrade that is larger than the software currently residing on the phone, the upgrade utility checks to see if there is any unused DAV space. If so, then the upgrade utility instructs the phone to redistribute the Flash sectors to convert free (empty) DAV blocks to FDI space. After the re-allocation is complete, then the new subscriber software is downloaded.

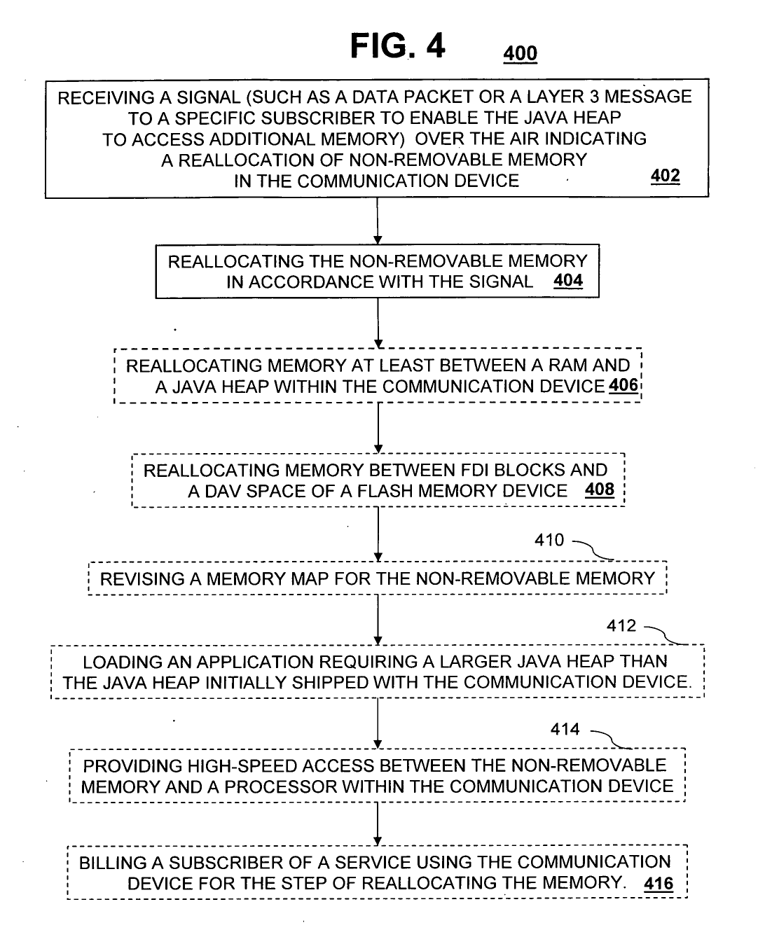

Referring to FIG. 4, a flow chart illustrating a method 400 of reallocating memory in accordance with an embodiment of the present invention is shown. The method 400 can include the step 402 of receiving a signal over the air indicating a reallocation of non-removable memory or a revision of a memory map in the communication device and the step 404 of reallocating the non-removable memory in accordance with the signal. The signal can be among other things packet data or a layer 3 message for a specific subscriber. The reallocation can optionally be at least between a random access memory and a java heap within the communication device at step 406 or between FDI blocks and a DAV space of a flash memory device at step 408. The step of reallocating can also optionally be the step of revising a memory map for the removable memory at step 410. The method 400 can also optionally include the step 412 of loading an application requiring a larger Java heap than the Java heap initially shipped with the communication device. Since the memory is non-removable, such memory can provide high-speed access to a processor within the communication device at step 414. The method can also include a step 416 of billing a subscriber of a service using the communication device for the step of reallocating the memory.

In light of the foregoing description, it should be recognized that embodiments in accordance with the present invention can be realized in hardware, software, or a combination of hardware and software. A communications system or device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

Additionally, the description above is intended by way of example only and is not intended to limit the present invention in any way, except as set forth in the following claims.

1. A method of reallocating memory in a communication device, comprising the steps of:
receiving a signal over the air indicating a reallocation of non-removable memory in the communication device; and
reallocating the non-removable memory in accordance with the signal.

2. The method of claim 1, wherein the step of reallocating the non-removable memory comprises the step of reallocating memory at least between a random access memory and a java heap within the communication device.

3. The method of claim 1, wherein the step of reallocating the non-removable memory comprises the step of reallocating memory between FDI blocks and a DAV space of a flash memory device.

4. The method of claim 2, wherein the method further comprises the step of loading an application requiring a larger java heap than the java heap initially shipped with the communication device.

5. The method of claim 1, wherein the method further comprises the step of providing high-speed access between the non-removable memory and a processor within the communication device.

6. The method of claim 1, wherein the step of reallocating the non-removable memory comprises revising a memory map for the non-removable memory.

7. The method of claim 1, wherein the step of receiving the signal over the comprises the step of receiving packet data.

8. The method of claim 1, wherein the step of receiving the signal over the air comprises receiving a layer 3 message to a specific subscriber to enable the java heap to access additional memory.

9. The method of claim 1, wherein the method further comprises the step of billing a subscriber of a service using the communication device for the step of reallocating the memory.

10. A communication device, comprising:
a non-removable memory preconfigured with a first amount of space allocated for random access memory and a second amount of space allocated for a heap; and
a processor coupled to the non-removable memory and programmed to receive a signal over the air to re-allocate at least the first amount of space and the second amount of space in accordance with the signal.

11. The communication device of claim 10, wherein the heap is a java heap.

12. The communication device of claim 10, wherein the communication device is selected from the group comprising a cellular phone, a two-way pager, a trunked-two-way radio, an iDEN radio, and a smart phone.

13. The communication device of claim 10, wherein the non-removable memory provides high speed access to the processor.

14. A communication system, comprising:
a base transmitter for transmitting a signal over the air indicating a reallocation of a non-removable memory within a portable communication device;
a non-removable memory within the communication device preconfigured with a first amount of space allocated for random access memory and a second amount of space allocated for a heap; and
a processor coupled to the non-removable memory and programmed to receive the signal over the air to re-allocate at least the first amount of space and the second amount of space in accordance with the signal.

15. The communication system of claim 14, wherein the heap is a java heap.

16. The communication system of claim 14, wherein the communication device is selected from the group comprising a cellular phone, a two-way pager, a trunked-two-way radio, an iDEN radio, and a smart phone.

17. The communication system of claim 14, wherein the non-removable memory provides high speed access to the processor.

18. The communication system of claim 14, wherein the non-removable memory is flash memory and the processor reallocates memory between FDI blocks and a DAV space of the flash memory device in accordance with the signal.
